(19) United States
(12) Patent Application Publication
(10) Pub. No.: US 2019/0171728 A1
(43) Pub. Date: Jun. 6, 2019

(54) CONTEXTUAL PREDICTIVE TYPE-AHEAD QUERY SUGGESTIONS

(71) Applicant: Microsoft Technology Licensing, LLC, Redmond, WA (US)

(72) Inventors: Swanand Wakankar, Campbell, CA (US); Dhruv Arya, Sunnyvale, CA (US); Saurabh Kataria, Newark, CA (US); Ada Cheuk Ying Yu, Santa Clara, CA (US)

(21) Appl. No.: 15/922,043

(22) Filed: Mar. 15, 2018

Related U.S. Application Data
(60) Provisional application No. 62/593,713, filed on Dec. 1, 2017.

(51) Int. Cl. G06F 17/30; G06F 9/451

(52) U.S. Cl. CPC G06F 17/3097; G06F 9/453; G06F 17/3053

(57) ABSTRACT

In some embodiments, the disclosed subject matter involves techniques for generating type-ahead query suggestions for a user in a specific subject or application domain that are ranked using confidence levels and contextual scoring. Partial query strings may be parsed for literal matching and be processed for spell checks, acronym expansion, and other expansion and rewriting of the partial query to a known possible query suggestion. Possible query suggestions are weighted using global feature metrics. Various weighting, confidence levels and merging based on scoring may be used to rank the suggestions. A machine learning model may be used to assist in assigning scores based on metrics on interaction in the search domain. Other embodiments are described and claimed.

### CROSS-REFERENCE TO RELATED APPLICATION

This application claims priority to U.S. Provisional Patent Application No. 62/593,713, filed on Dec. 1, 2017, the contents of which are hereby incorporated by reference in their entirety.

### TECHNICAL FIELD

An embodiment of the present subject matter relates generally to user interactive query searching, and, more specifically, techniques for generating query suggestions for a user that are ranked using confidence levels and contextual scoring.

### BACKGROUND

Various mechanisms exist for predictive query searching. Existing systems typically look at the literal string entered and expand to full words and phrases based on common searches. In some cases, a user's own search history is ranked higher. In some cases simple spelling corrections are suggested to the user.

However, existing systems do not expand acronyms or use context to rank suggestions or provide suggestions of a higher confidence. Therefore, a user is forced to type in significantly more text (e.g., a longer string) to get an appropriate suggestion. Further, query suggestions are not optimized for specific domains or applications.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an example user interface for entering a search query, according to an embodiment:

FIG. 2 illustrates an example user interface for entering a search query in a job search domain application with suggestions provided, according to an embodiment

FIG. 3 is a block diagram illustrating components of a system for generating contextual predictive type-ahead query suggestions, according to an embodiment;

FIG. 4 is a block diagram illustrating components of a system for generating contextual predictive type-ahead query suggestions using personalization, according to an embodiment:

FIG. 5 is a flow chart for an example method for providing type-ahead suggestions, according to an embodiment;

FIG. 6 is a block diagram illustrating an example of a machine upon which one or more embodiments may be implemented; and

FIG. 7 is an illustration of how query expansion and query suggestions are scored and ranked, according to an embodiment.

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter is a system and method relating to techniques for generating query suggestions for a user that are ranked using confidence levels and contextual scoring. In at least one embodiment, global features are used as context for the query suggestions. In another embodiment, personalized features are used to further refine the query suggestions. The query suggestions may use query expansion, rewriting and/or personalization techniques, as described herein. It will be understood that various embodiments may be applied to search applications of different domains. For illustrative purposes and to simplify explanation, the domain of job searches is used as an example application.

Query expansion and rewriting for the type-ahead will improve the recall for the type-ahead as many short-forms or common titles differ from standardized entity names companies use to post in a job offering post. Utilizing these techniques is expected to increase the Click through rate (CTR) and other engagement metrics for job search type-ahead.

Including personalization features in type-ahead query suggestions may significantly improve the user experience, and resulting CTR, since users have tendency to search for similar queries (e.g., companies or titles) for job search. Providing relevant personalized query suggestion may also result in a user having to type fewer characters in the search string before a relevant suggestion is provided, which may result in overall higher engagement level of users in job search.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

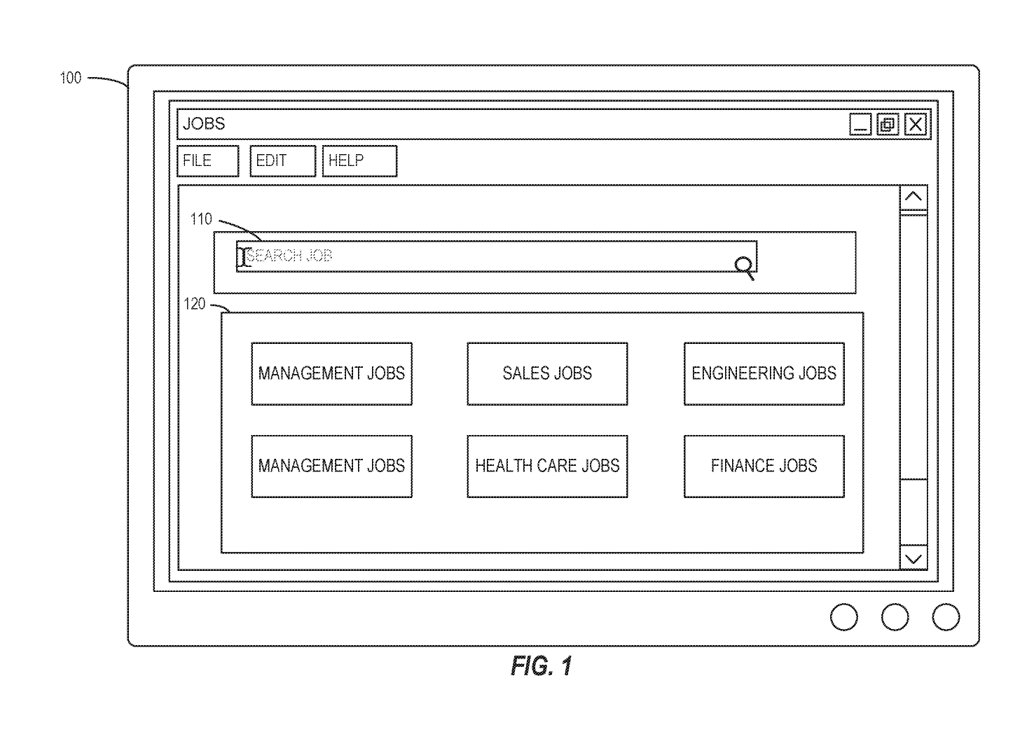

FIG. 1 illustrates an example user interface for entering a search query in a job search domain application 100, according to an embodiment. A user interface (UI) for searching jobs may include a text entry input field 110 for providing queries. Optionally, a user may select a specific industry first, as may be provided as selectable icons in box 120. It will be understood that many various UI forms may be used in a search application. In an example, a user enters a search query, partial search query or acronym in the text search input area 110. Current type-ahead in a job search domain may recognizes multiple entities (e.g., company, title, skill) and how many jobs are associated with those entities. However, the existing query does not expand and rewrite the query. For example, when a user enters the string “SDE” into a search field and user is in Software industry, then with very high probability, the user means “software development” or “software engineer.” Existing solutions result in irrelevant suggestions for short-forms which are used industry-wide or which are synonymous to each other.

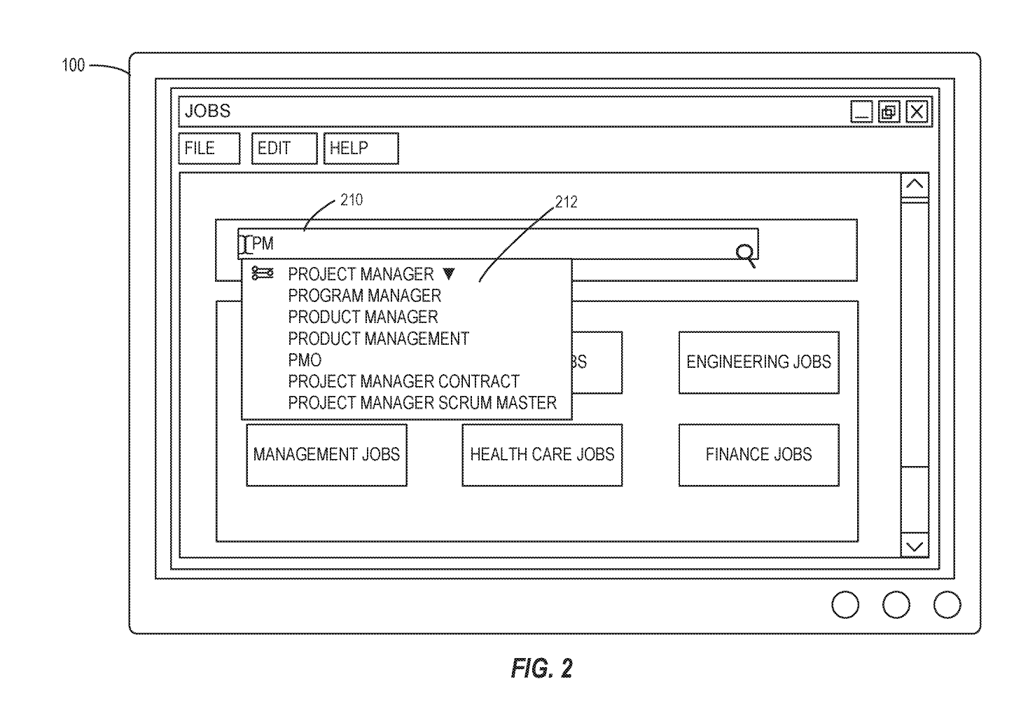

FIG. 2 illustrates an example user interface for entering a search query in a job search domain application with suggestions provided, according to an embodiment. In an example, a user enters the shortened string (e.g., an acronym) “PM” into the search area 212. A list of expanded suggestions is provided in the drop down selection box 212. Embodiments include suggestions of known global acronym expansions such as project manager, program manager, product manager, etc. In an optional extension, a user's personal profile information may be used to provide a customized ranking of query suggestions to the user. For instance, if the user currently has a title or role or product manager in a warehouse job, the product manager suggestion may be provided at the top of the list.

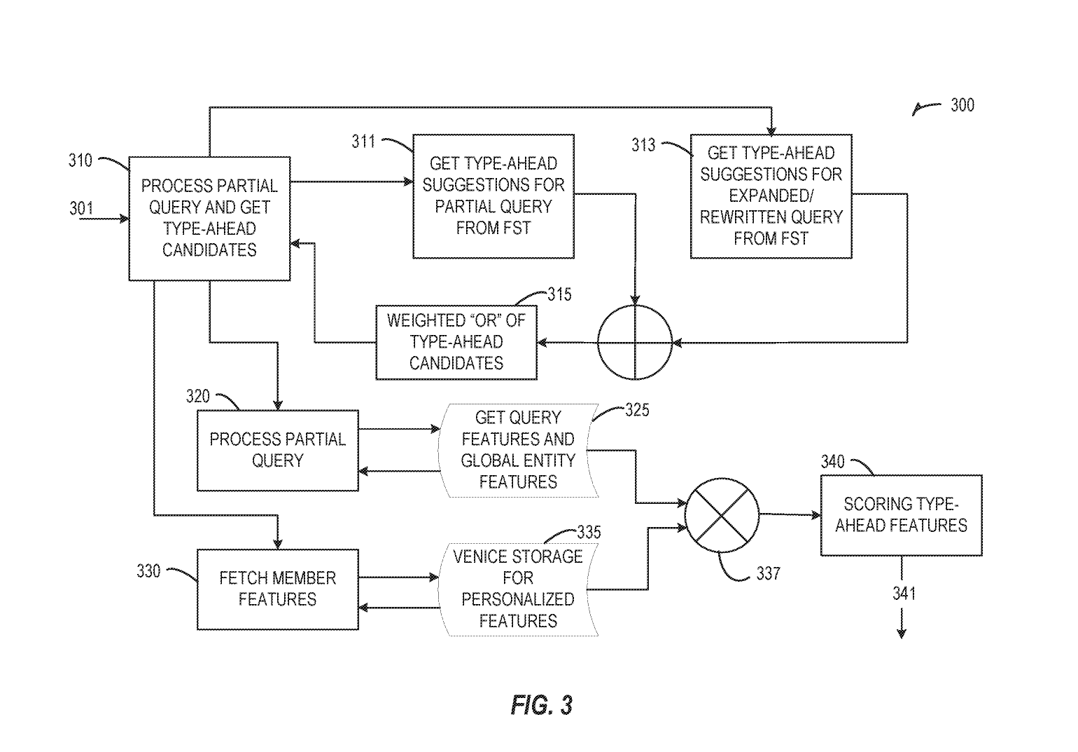

FIG. 3 is a block diagram illustrating components of a system 300 for generating contextual predictive type-ahead query suggestions, according to an embodiment. In an embodiment, a user (not shown) provides a partial query 301 in a search field. For illustrative purposes the following discussion will describe a use case for a job search query. It will be understood that embodiments may be applied to other domain searches with minimal adaption. The partial query 301 may be processed by logic or circuitry 310 to provide full query suggestions to a user. In an embodiment, processing logic 310 may comprise additional logic or circuitry. Type-ahead suggestion that have already been generated for the literal string entered as the partial query may be retrieved by logic 311. Key-value vectors for the literal string may be pre-generated and stored in data store where each vector may include the literal string, one or more suggested queries, and a confidence level that the query is relevant to the partial query. It will be understood that various methods of storage may be used. This process is similar to literal string query matches that may be performed for existing systems. As the user types additional characters in the string (e.g., partial query), type-ahead suggestions may be inferred from the literal string of the partial query. However, the confidence level for these queries may be low.

To improve confidence in suggestions provided, additional processing for spellcheck, acronym check, clustering, and query expansion may be performed by logic 313. In an embodiment, a spell check is performed on the partial query. If there are possible spelling or typographical errors, the corrected partial query may be used for expansion or rewriting, in addition to the literal string. Further processing may be performed to determine whether the literal sting is an acronym. For instance common acronyms for jobs, roles, industry, skills and other job-related keywords may be stored, with one or more suggested expansions. Once expanded, suggested queries may be determined. In search engines typically used on the Internet, acronym expansion may be time consuming, inefficient, and provide irrelevant type-ahead suggestions, which is why generalized search engines do not perform this function. However, in embodiments as described herein, acronyms may be inferred based on context, for instance job roles, industries, company names, etc., rather than forced to search the whole world of possible acronyms.

In an example, a user may type the literal string “SED” (e.g., q=[SED). This may be a misspelling of an intended q=[SDE]. Logic 311 may find few or no matches for this literal string. Many words begin with the letters “SED” but there may be few or none that are related to the job search domain. If there are no suggestions, the partial query suggestion may provide only q=[SED] with a low confidence level. However, the expansion logic 313 may provide a query vector that includes a suggested spelling correction to “SED” which is a known term in the job search domain, e.g., q=[SED, SDE,0.8], where the 0.8 is a confidence level associated with the spelling correction. Acronym checking may be performed which provides additional expansion of the acronym SDE and may provide a vector q=[SED, SDE, 1.0, software developer, 1.0, software engineer, 1.0], where the first element is the literal string, the second and third elements are the spell correction and confidence level, respectively, and successive pairs of elements are suggested expansion or rewriting of the acronym with associated confidence levels.

In an embodiment, a confidence level is provided for query expansion/rewriting confidence. In one embodiment, the confidence level of an element, or query entity, is based on a CTR of the element/entity. For example, the confidence level of an element may be a percentage of times that members selected search results associated with the element after typing the initial query. As another example, the confidence level of an element may be a percentage of times that members searched for the element after the initial query. The members whose actions are used in determining the confidence level of an element may be limited to members that satisfy certain criteria, such as members of the same industry. For instance, a confidence level may be calculated from the CTR for high volume queries by members of the same industry. Other embodiments may use other member-related criteria that may be derived from member profiles and activity with the domain application. For instance, an industry-role pair of criteria may be used as combined criteria in a job search domain, e.g., CTR calculations may be limited to members with the industry-role combination of traits. Another embodiment may calculate the confidence level by using a machine learning algorithm such as logistic regression. The confidence levels may be pre-associated with the expanded query string and retrieved from a data store or list in memory.

In an embodiment, a confidence-based entity similarity map may be generated based on user-queries and a CTR, e.g., what the user actually selected to apply as the query. This map may be generated offline; then when a query is received, the query may be rewritten based on the synonyms/expansions derived from the confidence-based entity similarity map. Each query suggestion may be associated with a score, as well as confidence level. Logic to perform a weighted OR of the literal mapping 311 and expansion mapping 313 provides a initially ranked list of query suggestions, based on the weighting, at 315.

Each suggestion may also have score derived from a variety of signals or metrics regarding click-through rate (CTR) for the query suggestion, as correlated with the initial partial query, frequency of appearance of the term in the job posting database, open job count for the entity combination, member industry based search counts for the entity combination, member search history, exact query matches, etc. Various signals may be used and may vary based on what metrics are collected in the domain application, whether user search history is available, etc.

In an embodiment, the rewritten query may be expressed as in Equations (1) and (2), below.

Rewritten Query=(q:rawQuery OR q:SIMILAR_ENTITIES(rawQuery)), EQ (1)
where q:rawQuery indicates the initial literal string entered and
q:SIMILAR_ENTITIES(rawQuery) indicates the expanded queries as a function of the rawQuery.

SCORE_{SUGGESTION}=SCORE_{SUGGESTION FROM THE RANKING}*CONFIDENCE_SCORE_{FOR THE ENTIY}, EQ. (2)
where SCORE_{SUGGESTION} indicates a final score for the specific suggestion;
SCORE_{SUGGESTION FROM THE RANKING} indicates an initial score based on factors as outlined below; and CONFIDENCE_SCORE_{FOR THE ENTITY} indicates a confidence score for the entity from which the suggestion was generated.

In an example, when the rawQuery is “SED,” entities used may be “SED” and “SDE,” each having a confidence level associated with it. Suggestions derived may include “software development engineer” and “software engineer,” each having an associate SCORE_{SUGGESTION FROM THE RANKING}. The final score suggestion for the “software engineer” suggestion is the product of the entity confidence score (e.g., for SDE), and the suggestion score for the suggestion.

In an example, a combination of entities may be entered in the partial query. For instance, if a user is looking for jobs at LinkedIn for software developers, an initial partial query may be “SDE LI,” which includes two entities including a tile/role (e.g., SDE), and company (e.g., LinkedIn). In this case, a combination of entities may be entered, e.g., SDE and LI. Each entity within the partial query may have its own confidence score/level.

In an embodiment, the SCORE_{SUGGESTION} may be calculated as in equation (3), below.

SCORE_{SUGGESTION}=(W1*historical-SearchCount/CTR of the entity combination)+(W2*Open-JobCount-For-The-entity-combination)+(W3*MemberIndustryBasedSearchCounts-for-entityCombination)+(W4*MemberSearchHistory)+(W5*ExactQuervMatch), EQ. (3)

where Wn indicates a weighting for the feature. Weighted features may include, but are not limited to:
pre-calculated signal/metrics for historical search counts or CTR for the entity or entity combination,
open job count for the entity or entity combination;
member-industry based search counts for the entity or entity combination;
member search history, when available; and
exact query matches.

It will be understood that other metrics or features may be used for weighting for job search and other various domains. For instance, additional signals may be used, such as Number-of-Applies (e.g., a count of the number of times a candidate has applied for a job matching the query suggestion), OR number-of saves-by-all members (e.g., the number of time any member has saved a job listing matching the query suggestion), OR number-of-clicks-in-search-results etc. Training data may be generated from type-ahead use, including identifying the position at which users choose a type-ahead suggestion instead of continuing to type more characters, and for which query this occurred. In an embodiment, weights at logic 315 may be selected where the FINAL_SCORE is the product of SCORE_{SUGGESTION FROM THE RANKING} and CONFIDENCE_SCORE_{FOR THE ENTITY FOR WHICH THE SUGGESTION WAS GENERATED}. Then the ordered list of suggestions may be generated based on the FINAL_SCORE for each suggestion.

In an embodiment, the results from entities using the Score Suggestion formula EQ. (2) may be blended to represent final type-ahead suggestions to the user. The entity similarity map may be generated using machine learning. In an embodiment, a curated entity similarity map may be manually generated for entities which are most represented in a Job Search (mainly company, title and skill). Query expansion and rewriting remains the same as explained above.

In an embodiment, ranking for suggestions as provided at 315 may be presented to the user. However, ranking of suggestions may be improved by obtaining additional suggestions using features and global entity features, as described in the scoring algorithms above. The partial query may be processed for the various entities, as discussed above, in logic 320. The global signals or metrics for CTR, open job counts, member search counts, etc., may be retrieved from a memory store 325 and used for processing. It will be understood that the metrics may be retrieved using an application program interface (API) call to an appropriate database interface or by using a data mining assistant such as Hadoop to query data from a robust database.

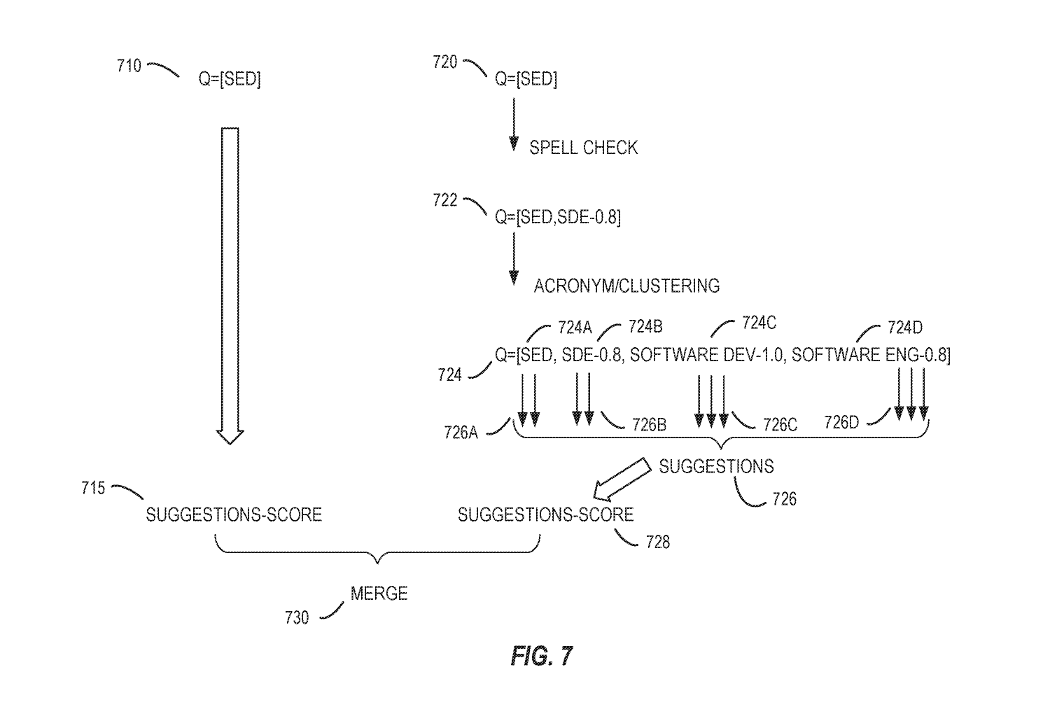

FIG. 7 is an illustration of how query expansion and query suggestions are scored and ranked, according to an embodiment. As described above, a literal text string query is received from a user. The example string “SED” 710, 720 is used to illustrate the process. In existing systems, suggestions based only on this literal text string are used. In an embodiment, the query 720 is processed for possible spelling corrections and additional base queries may be applied. In the example, after the spell check, two queries 722 may be used for suggestions, e.g., SED and SDE. In an example, a confidence level is associated with the queries derived from the spell check. In this example, query SDE has a confidence level of 0.8.

As described above, the initial query and any spell check derived queries are processed for likely acronyms and clustering resulting in a vector 724 of possible queries 724A-D. In the example, there may be few or no known acronym expansions for SED 724A in the subject domain. However, SDE 724B may be expanded for likely acronyms of SOFTWARE DEV 724C and SOFTWARE ENG 724D. In the example, the spell check to SDE 724B has a confidence level of 0.8. The acronym expansion to SOFTWARE DEV 724C has a confidence level of 1.0. And the acronym expansion to SOFTWARE ENG 724D has a confidence level of 0.8.

Each possible query 724 is then processed to identify query suggestions 726A-D. In an embodiment, each query 724A-D may have one or more corresponding suggestions 726. In an example, the query SOFTWARE DEV 724C may provide a variety of suggestions 726C, such as, but not limited to, SOFTWARE DEVELOPER, SOFTWARE DEVELOPMENT ENGINEER, SOFTWARE DEVELOPMENT PROCESS, etc. Based on historical information, for instance CTR information, or context of the search, each suggestion may be associated with a suggestion score that corresponds to the query. In an example, a suggestion of SOFTWARE DEVELOPER may have a higher suggestion score for the query SOFTWARE DEV than a suggestion of SOFTWARE DEVELOPMENT PROCESS, has for the same query, based on CTR data for the query SOFTWARE DEV.

A suggestion score for a suggestion 726 may be multiplied by the confidence score of the associated query 724 to result in a ranking score. The ranking scores may be returned as a vector of suggestions scores 728. The original query 710 may have a default confidence score of 1.0. In an embodiment, the literal text query may have a default confidence score lower than 1.0. The initial query suggestion score 715 may be merged 730 with the processed and expanded suggestions scores 728 to provide a ranked list of suggestions that may then be presented to the user. In an embodiment, a total number of suggestions 726 may be capped at a pre-determined threshold. In an example, the threshold may be 250 suggestions. In another example, the threshold may be 100 or lower. Capping the number of suggestions to be merged may save processing time, reduce memory costs, and reduce lag time. In an embodiment, 10 suggestions may be presented to the user without the opportunity to page through. Thus, any suggestion ranked lower than the top 10 will not be presented. The number of suggestions presented to the user may be more or fewer than 10, depending on display limitations, user preference, pre-determined maximum, etc. For instance, if the user does not see a relevant suggestion in those 10 presented, then the user may just continue to enter text until a relevant suggestion is derived from the partial text.

Referring again to FIG. 3, type-ahead in job search may recognizes multiple entities (like company, title, skill) and how many jobs are associated with those entities. However, current search techniques do not personalize the type-ahead suggestions based on user activity. For instance, if a user starts typing “de” then the search function may suggest “developer” as first suggestion even though the user is a “designer.”

Embodiments may use various techniques to customize query suggestions based on the user context. In an embodiment, a two-pass ranker approach may be used. In this approach, a ranking provided by the non-personalized type-ahead may be used as a first pass, as discussed above. This first pass utilizes global features such as: what user has literally typed (to recommend type-ahead); popular entities for that query; number of spelling mistakes allowed/corrected; how many jobs are available for every entity; how many times each entity is searched, etc. The first pass provides a rank list with score associated with every type-ahead suggestion (e.g., at 315, or 325). In a second pass, member features and cross features (member features and type-ahead suggestion features) are applied to the scoring and ranking to refine the query suggestions at logic 330.

In an embodiment, member features may be retrieved at logic 330 from a database such as a Venice database 335. Venice storage 335 is an asynchronous data serving platform using a distributed key-value storage system. Venice storage 335 specializes in serving the derived data bulk loaded from offline systems (such as Hadoop) as well as the derived data streamed from nearline systems. Because the derived data use cases do not require strong consistency, read-your-writes semantics, transactions nor secondary indexing, Venice 335 may be highly optimized for the content use cases for query suggestions, and deliver a simpler, more efficient, architecture than consistent synchronous systems like Espresso and Oracle) relational databases. Since the data is stored as key-value rather than relational, a set of data to be used for query suggestions may be stored under literal partial queries, spell-corrected partial queries, and/or have key combinations for multiple entities within the partial search, as relates to a member usage (e.g., associated with a member ID).

Personalized suggestion scoring may include weighted features such as:
inferred or identified member industry;
inferred or identified member role title;
member industry based search counts for entity combination;
member search history, including:
   CTR
   search query counts coming from members of same title/industry/skill/company as that of current member;
   saved searches by the member;
   companies followed by the member;
   influencers/skills followed by member; etc.
      Personalized scoring may be as robust or limited as the available historical data/metrics available by user. Features above are identified as possible features for scoring, but any combination of subsets of these features may be used, including features not listed. Further, personalized scoring may omit certain features in order to maintain low latency and keep the size of the Venice storage 335 to a manageable level. In an embodiment, personalized scoring 330 may be merged 337 with the global scoring 320 based on pure ordering of score, but may also utilize some thresholds such as Blacklisted words, or minimum open jobs, or minimum number of times the entity was searched. Once the scoring is merged 337, a final scoring may be provided by logic 340. A final scoring may rank the query suggestions for ordering when presented to the user 341 as an ordered list of suggestions. When and if the user selects (e.g., clicks on, or touches on a touch screen), the CTR associated with the partial query and the selected suggestion may be incremented to update the previously stored CTR.

An advantages of this two-pass approach is that the pipeline and ranking infrastructure remains virtually the same for a guest user with no recorded profile information, users with less engagement, and heavy users with robust profiles and CTR history. The first pass uses only global features so it is lightweight and latency is less. However, a possible result of the two-pass technique may be that there is high risk of over-personalization since in the second pass, first pass output is taken as a candidate list and gets re-ranked based on member preferences. However, this potential disadvantage may be mitigated by weighting personalization as lower importance. If the query (typed) features are taken into consideration, then the scoring and ranking may be duplicated in the first pass and second pass, resulting in higher latency. It may be difficult to tune the second pass ranker as it takes a score of first pass ranker as a feature. If the underlying score distribution changes, then the second pass ranker should be retrained, as well.

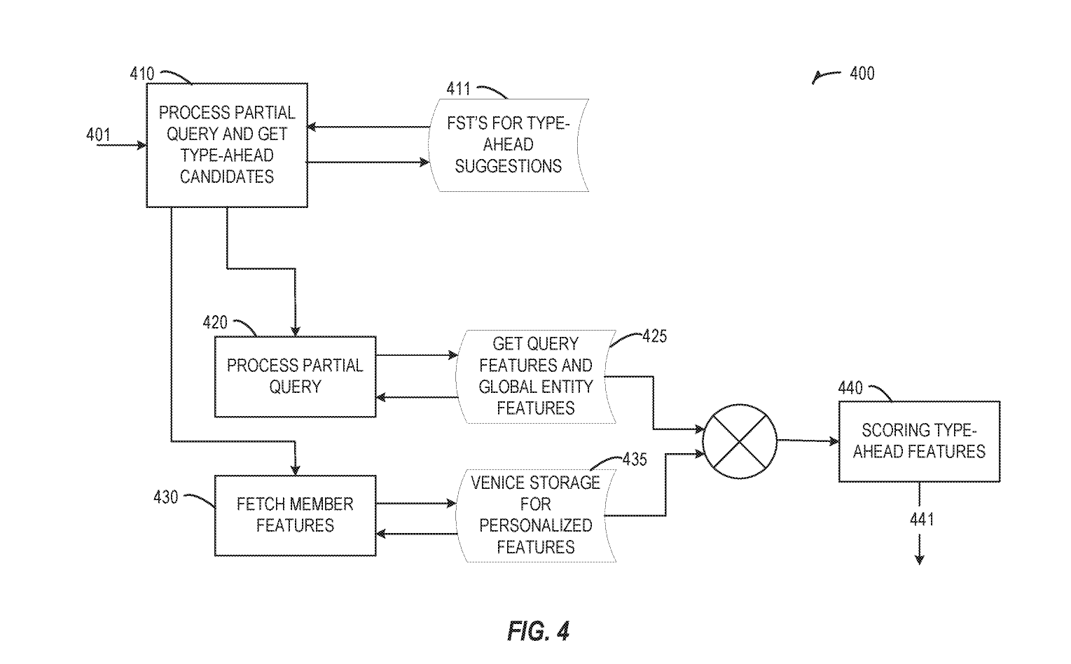

Another embodiment uses a personalized boosting approach. FIG. 4 is a block diagram illustrating components of a system 400 for generating contextual predictive type-ahead query suggestions using personalization, according to an embodiment. In this approach, a rank-list may be provided in a single pass. However, during scoring, the score of some entities may be boosted (e.g., raised) based on member preference. Thus, the personalization component does not completely re-rank the list. Instead, the scores for some suggestions may be altered.

In an embodiment, a user (not shown) provides a partial query 401 in a search field. For illustrative purposes the following discussion will describe a use case for a job search query. It will be understood that embodiments may be applied to other domain searches with minimal adaption. The partial query 401 may be processed by logic or circuitry 410. This processing may be similar to that of logic 313 of FIG. 3. In this embodiment, the literal query scoring is omitted because it may be assumed that the personalization feature scoring will override any suggestions from literal matching. Thus, the weighted OR logic of 315 (FIG. 3) may be omitted. This improves latency delays. Logic for processing the partial query 410 may access the previously calculated partial query suggestions for expanded and spellchecked entities from storage 411. The initial query suggestions may be used for logic 420 to utilize the global features as discussed above for logic 320 of FIG. 3, using global signals or metrics as stored in 425. Member personalization in logic 420 may be performed similarly to logic 330 of FIG. 3, using key-value data in a Venice data storage 435. The global and personalized scoring may be merged and final scoring calculated by logic 440. Various weights may be used to weight the personalization to more or less important as is appropriate for the subject domain. The ordered ranking of query suggestions are provided to the user at 441.

In an embodiment, the ranking algorithm may be modified to utilize a trained machine learning model. When a model is used to train a ranking and scoring model for preparing relevant query suggestions, a complex two-pass technique may not be necessary. An advantages of this technique may be that because only some of the suggestion scores are modified, personalizing the results has very low risk of not being relevant to the typed query. However, some one-pass booster techniques may result in an attempt to retrieve personalized features for every user, which may increase latency time in the search, as compared to the two-pass ranker approach. To mitigate this effect, a member may have their own rank, and member ranks below a certain threshold may skip the personalization process, or alternatively, perform the two-pass process instead.

Various embodiments as described above may be selected for applications of varying scales and domains. In some applications, user personalization may be more important than global searches. In the domain involving movie searches, for instance, while using an entertainment streaming service or preparing to purchase DVD from an online marketplace, a user may prefer the query to be more personalized, and cares little for global searches and features. It will be understood that the advantages and disadvantages above may be applicable or inapplicable to the domain selected for the query suggestions, and the domain may drive the implementations and techniques used.

In an embodiment implementing a job search domain, it may be very important for the suggestion to be a completion of what user has literally typed. In the two pass ranking approach, there may be less control over the completion of a typed query unless the partial query is taken into consideration, which is an overhead cost. Thus, the personalized boosting approach may be easier to manage and scale.

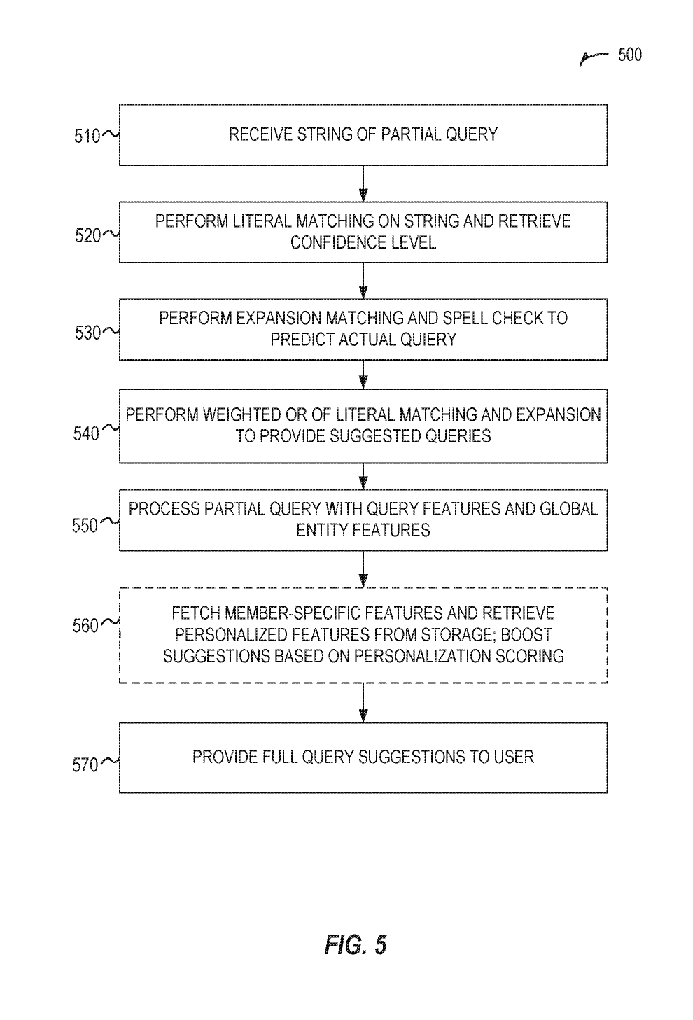

FIG. 5 is a flow chart for an example method 500 providing type-ahead suggestions, according to an embodiment. In an embodiment, a partial query string is received in block 510. In a two pass approach, literal matching may be performed on the string, in block 520. A confidence level corresponding to the literal string may also be retrieved with the matching. For a one pass approach with personalization, as discussed above, the literal matching may be omitted.

An expansion of the partial query, with spell check and acronym expansion, as described above, may be performed in block 530 to provide additional possible partial queries beyond a literal match. When a two pass approach is used a weighted OR of literal matching and expansion to provide suggested queries may be performed in block 540. Partial query suggestions may be further processed in block 550, for instance, using global click through or job related metrics to provide more refined scoring of individual suggestions. As described above, each entity or entity combination may include a confidence level for a selected partial query. Each partial query may be correlated with one or more possible query suggestions for the partial query. The partial query may be associated with a confidence level. The query suggestions may be associated with a score based on global features or metrics and may be based on weighted combinations of confidence levels associated with the literal or inferred partial query (e.g., for a spell checked and corrected query, expanded acronym, etc.). As discussed above, the weighted scoring may be used to rank the suggestions to be provided to the user in a rank order, in block 570.

In an alternate embodiment, personalization using member specific metrics may be used to provide a ranking of higher confidence. In an embodiment, member-specific features and metrics may be retrieved in block 560. In an embodiment, key-value information correlating a member identifier (member-Id) with various features may be stored in a data store such as a Venice database. Retrieval of personalized features may aid in generation of query suggestions and scoring for ranking of suggestions. Scoring of the global suggestions may be boosted with personalization scoring or be merged using weighting, as discussed above. The boosted or merged query suggestions may be provided to the user in rank ordering, in block 570.

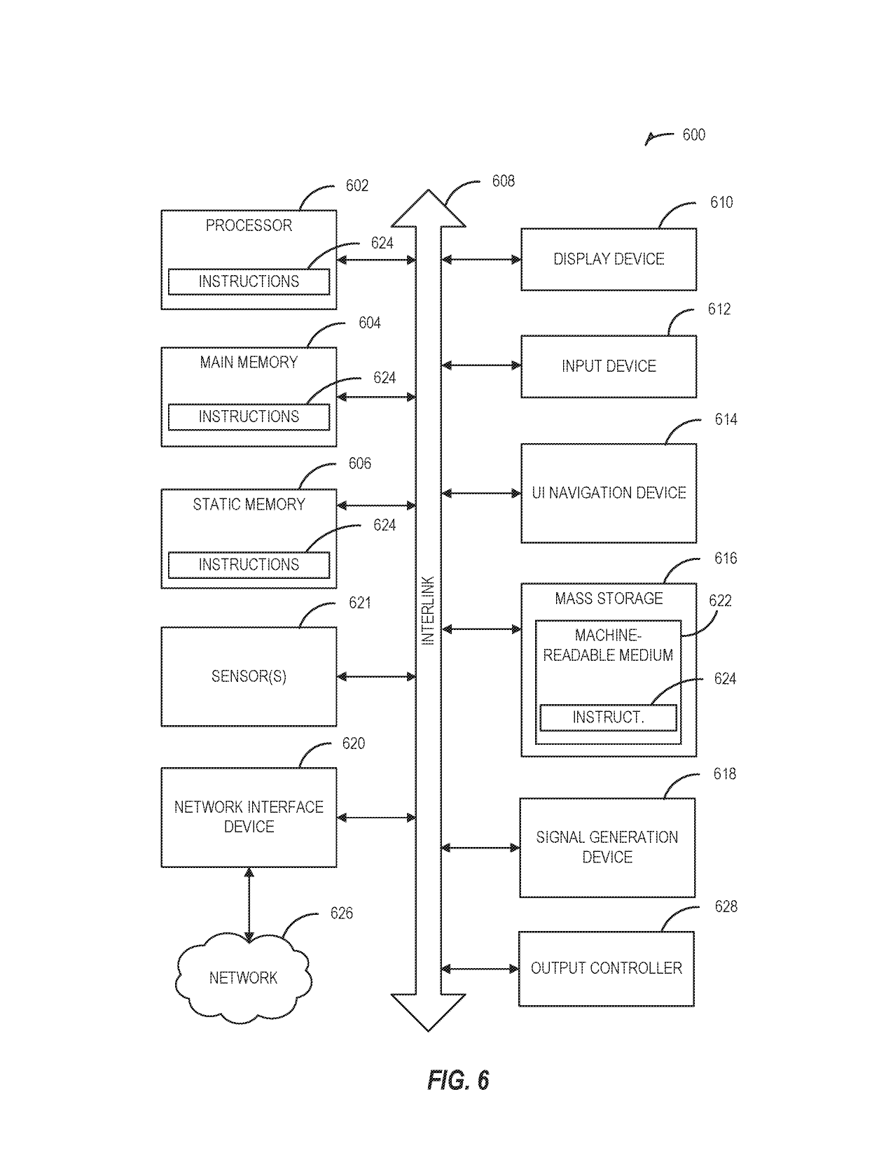

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### ADDITIONAL NOTES AND EXAMPLES

Examples may include subject matter such as a method, means for performing acts of the method, at least one machine-readable medium including instructions that, when performed by a machine cause the machine to performs acts of the method, or of an apparatus or system for providing contextual type-ahead query suggestions, according to embodiments and examples described herein.

Example 1 is a method for providing type-ahead query suggestions, comprising: receiving a partial query entered by a user in a user interface, wherein the partial query is specific to a search domain; identifying one or more type-ahead query candidates from the partial query, wherein each of the one or more type-ahead query candidates has a corresponding confidence level, and wherein the confidence level is a measure of how relevant the type-ahead query candidate is to the partial query, wherein at least one of the type-ahead query candidates is an expansion of the partial query using spelling correction or acronym expansion; for each of the one or more type-ahead query candidates, identifying at least one query suggestion corresponding to the type-ahead query candidate and having a suggestion score based on at least one of click-through-rate or context associated with global features of the search domain; scoring of the query suggestions, wherein a score of the query suggestion is based on both the suggestion score associated with the query suggestion and the confidence level of the corresponding type-ahead query candidate; comparing the scores of the query suggestions corresponding to type-ahead candidates; ranking the query suggestion based on the score of each query suggestion; and providing the ranked query suggestions to the user in a selectable user interface corresponding to an application within the search domain to allow the user to select a desired query suggestion before a full query has been entered by the user.

In Example 2, the subject matter of Example 1 optionally includes wherein providing the ranked query suggestions to the user further comprises: selecting a subset of the ranked query suggestions as top ranked type-ahead suggestions, where the top ranked type-ahead suggestions comprise an N threshold highest ranking query suggestions, wherein N is a pre-determined threshold; and providing the top ranked query suggestions to the user in the selectable user interface.

In Example 3, the subject matter of any one or more of Examples 1-2 optionally include generating one or more type-ahead query candidates from probable spelling correction candidates for the partial query, when a spelling correction candidate exists; and generating one or more type-ahead query candidates by treating the partial query and the one or more type-ahead query candidates generated during spelling correction as an acronym and identifying probable acronym expansions using a database of known global acronym expansions corresponding to the search domain.

In Example 4, the subject matter of any one or more of Examples 1-3 optionally include wherein key-value vectors for a literal string corresponding to the partial query are pre-generated and stored in database where each key-value vector includes the literal string, the one or more type-ahead query candidates, and a confidence level that each of the one or more type-ahead query candidates is relevant to the partial query.

In Example 5, the subject matter of any one or more of Examples 1-4 optionally include dynamically updating the ranked query suggestions presented to the user, responsive to the user modifying the partial query.

In Example 6, the subject matter of any one or more of Examples 1-5 optionally include wherein the search domain is in a field of job searching within a job-related professional social network, and wherein the search domain includes contextual information for at least one of industry, company, job title, skill or pre-defined job-related keywords.

In Example 7, the subject matter of any one or more of Examples 1-6 optionally include wherein acronym expansion of the partial query is inferred based on context of the partial query and the search domain.

In Example 8, the subject matter of any one or more of Examples 1-7 optionally include deriving a set of type-ahead query candidates by calculating a weighted OR of a literal matching of the partial query and the one or more type-ahead query candidates.

Example 9 is at least one computer readable storage medium having instructions stored thereon, the instructions when executed on a machine cause the machine to: receive a partial query entered by a user in a user interface, wherein the partial query is specific to a search domain; identify one or more type-ahead query candidates from the partial query, wherein each of the one or more type-ahead query candidates has a corresponding confidence level, and wherein the confidence level is a measure of how relevant the type-ahead query candidate is to the partial query, wherein at least one of the type-ahead query candidates is an expansion of the partial query using spelling correction or acronym expansion; for each of the one or more type-ahead query candidates, identify at least one query suggestion corresponding to the type-ahead query candidate and having a suggestion score based on at least one of click-through-rate or context associated with global features of the search domain; score the query suggestions, wherein a score of the query suggestion is based on both the suggestion score associated with the query suggestion and the confidence level of the corresponding type-ahead query candidate; compare the scores of the query suggestions corresponding to type-ahead candidates and partial query; rank the query suggestions based on the score of each query suggestion; and provide the ranked query suggestions to the user in a selectable user interface corresponding to an application within the search domain to allow the user to select a desired query suggestion before a full query has been entered by the user.

In Example 10, the subject matter of Example 9 optionally includes wherein instructions to provide the ranked query suggestions to the user further comprise: select a subset of the ranked query suggestions as top ranked type-ahead suggestions, where the top ranked type-ahead suggestions comprise an N threshold highest ranking query suggestions, wherein N is a pre-determined threshold; and provide the top ranked query suggestions to the user in the selectable user interface.

In Example 11, the subject matter of any one or more of Examples 9-10 optionally include instructions to: generate one or more type-ahead query candidates from probable spelling correction candidates for the partial query, when a spelling correction candidate exists; and generate one or more type-ahead query candidate by treating the partial query and the one or more type-ahead query candidates generated during spelling correction as an acronym and identifying probable acronym expansions using a database of known global acronym expansions corresponding to the search domain.

In Example 12, the subject matter of any one or more of Examples 9-11 optionally include wherein key-value vectors for a literal string corresponding to the partial query are pre-generated and stored in database where each key-value vector includes the literal string, the one or more type-ahead query candidates, and a confidence level that each of the one or more type-ahead query candidates is relevant to the partial query.

In Example 13, the subject matter of any one or more of Examples 9-12 optionally include instructions to: dynamically update the ranked query suggestions presented to the user, responsive to the user modifying the partial query.

In Example 14, the subject matter of any one or more of Examples 9-13 optionally include wherein the search domain is in a field of job searching within ajob-related professional social network, and wherein the search domain includes contextual information for at least one of industry, company, job title, skill or pre-defined job-related keywords.

In Example 15, the subject matter of any one or more of Examples 9-14 optionally include wherein acronym expansion of the partial query is inferred based on context of the partial query and the search domain.

In Example 16, the subject matter of any one or more of Examples 9-15 optionally include instructions to: derive a set of type-ahead query candidates by calculating a weighted OR of a literal matching of the partial query and the one or more type-ahead query candidates.

Example 17 is a system for providing type-ahead query suggestions, comprising: a processor configured to execute an application corresponding to a search domain, the application coupled to a user interface configured to enable a user to enter a search query corresponding to the search domain; and a contextual type-ahead query suggestion engine communicatively integrated with the user interface of the application and executing on at least the processor or an additional processor, the contextual type-ahead query suggestion engine configured to: receive the search query entered by the user in the user interface, wherein the search query is specific to the search domain; identify one or more type-ahead query candidates from the search query, wherein each of the one or more type-ahead query candidates has a corresponding confidence level, and wherein the confidence level is a measure of how relevant the type-ahead query candidate is to the search query, wherein at least one of the one or more type-ahead query candidates is an expansion of the search query using spelling correction or acronym expansion, wherein the corresponding confidence level is accessed from a database of key-value vectors, each key-value vector comprising a literal string associated with the search query, the one or more type-ahead query candidates, and a confidence level that each of the one or more type-ahead query candidates is relevant to the search query, and wherein the confidence levels are calculated offline based on the search domain and historical user searches; for each of the one or more type-ahead query candidates, identify at least one query suggestion corresponding to the type-ahead query candidate and having a suggestion score based on at least one of click-through-rate or context associated with global features of the search domain; score the query suggestions, wherein a score of the query suggestion is based on both the suggestion score associated with the query suggestion and the confidence level of the corresponding type-ahead query candidate; compare the scores of the query suggestion corresponding to type-ahead query candidate and search query; rank the query suggestions based on the score of each query suggestions; and provide the ranked query suggestions to the user in the user interface to allow the user to select a desired query suggestion from the ranked query suggestions before a full query has been entered by the user.

In Example 18, the subject matter of Example 17 optionally includes wherein the contextual type-ahead query suggestion engine is further configured to: dynamically update the ranked query suggestions presented to the user, responsive to the user modifying the search query.

In Example 19, the subject matter of any one or more of Examples 17-18 optionally include wherein the search domain is in a field of job searching within a job-related professional social network, and wherein the search domain includes contextual information for at least one of industry, company, job title, skill or pre-defined job-related keywords.

In Example 20, the subject matter of any one or more of Examples 17-19 optionally include wherein the contextual type-ahead query suggestion engine is further configured to: generate one or more type-ahead query candidates from probable spelling correction candidates for the search query, when a spelling correction candidate exists; and generate one or more type-ahead query candidates by treating the search query and the one or more type-ahead query candidates generated during spelling correction as an acronym and identify probable acronym expansions using a database of known global acronym expansions corresponding to the search domain.

Example 21 is a system configured to perform operations of any one or more of Examples 1-20.

Example 22 is a method for performing operations of any one or more of Examples 1-20.

Example 23 is a machine readable medium including instructions that, when executed by a machine cause the machine to perform the operations of any one or more of Examples 1-20.

Example 24 is a system comprising means for performing the operations of any one or more of Examples 1-20.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, and/or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

What is claimed is:

1. A method for providing type-ahead query suggestions, comprising:
receiving a partial query entered by a user in a user interface, wherein the partial query is specific to a search domain;
identifying one or more type-ahead query candidates from the partial query, wherein each of the one or more type-ahead query candidates has a corresponding confidence level, and wherein the confidence level is a measure of how relevant the type-ahead query candidate is to the partial query, wherein at least one of the type-ahead query candidates is an expansion of the partial query using spelling correction or acronym expansion;
for each of the one or more type-ahead query candidates, identifying at least one query suggestion corresponding to the type-ahead query candidate and having a suggestion score based on at least one of click-through-rate or context associated with global features of the search domain;
scoring of the query suggestions, wherein a score of the query suggestion is based on both the suggestion score associated with the query suggestion and the confidence level of the corresponding type-ahead query candidate;
comparing the scores of the query suggestions corresponding to type-ahead candidates;
ranking the query suggestion based on the score of each query suggestion; and
providing the ranked query suggestions to the user in a selectable user interface corresponding to an application within the search domain to allow the user to select a desired query suggestion before a full query has been entered by the user.

2. The method as recited in claim 1, wherein providing the ranked query suggestions to the user further comprises:
selecting a subset of the ranked query suggestions as top ranked type-ahead suggestions, where the top ranked type-ahead suggestions comprise an N threshold highest ranking query suggestions, wherein N is a pre-determined threshold; and
providing the top ranked query suggestions to the user in the selectable user interface.

3. The method as recited in claim 1, further comprising:
generating one or more type-ahead query candidates from probable spelling correction candidates for the partial query, when a spelling correction candidate exists; and
generating one or more type-ahead query candidates by treating the partial query and the one or more type-ahead query candidates generated during spelling correction as an acronym and identifying probable acronym expansions using a database of known global acronym expansions corresponding to the search domain.

4. The method as recited in claim 1, wherein key-value vectors for a literal string corresponding to the partial query are pre-generated and stored in database where each key-value vector includes the literal string, the one or more type-ahead query candidates, and a confidence level that each of the one or more type-ahead query candidates is relevant to the partial query.

5. The method as recited in claim 1, further comprising:
dynamically updating the ranked query suggestions presented to the user, responsive to the user modifying the partial query.

6. The method as recited in claim 1, wherein the search domain is in a field of job searching within ajob-related professional social network, and wherein the search domain includes contextual information for at least one of industry, company, job title, skill or pre-defined job-related keywords.

7. The method as recited in claim 1, wherein acronym expansion of the partial query is inferred based on context of the partial query and the search domain.

8. The method as recited in claim 1, further comprising:
deriving a set of type-ahead query candidates by calculating a weighted OR of a literal matching of the partial query and the one or more type-ahead query candidates.

9. At least one computer readable storage medium having instructions stored thereon, the instructions when executed on a machine cause the machine to:
receive a partial query entered by a user in a user interface, wherein the partial query is specific to a search domain;
identify one or more type-ahead query candidates from the partial query, wherein each of the one or more type-ahead query candidates has a corresponding confidence level, and wherein the confidence level is a measure of how relevant the type-ahead query candidate is to the partial query, wherein at least one of the type-ahead query candidates is an expansion of the partial query using spelling correction or acronym expansion;
for each of the one or more type-ahead query candidates, identify at least one query suggestion corresponding to the type-ahead query candidate and having a suggestion score based on at least one of click-through-rate or context associated with global features of the search domain;
score the query suggestions, wherein a score of the query suggestion is based on both the suggestion score associated with the query suggestion and the confidence level of the corresponding type-ahead query candidate;
compare the scores of the query suggestions corresponding to type-ahead candidates and partial query;
rank the query suggestions based on the score of each query suggestion; and
provide the ranked query suggestions to the user in a selectable user interface corresponding to an application within the search domain to allow the user to select a desired query suggestion before a full query has been entered by the user.

10. The medium as recited in claim 9, wherein instructions to provide the ranked query suggestions to the user further comprise:
select a subset of the ranked query suggestions as top ranked type-ahead suggestions, where the top ranked type-ahead suggestions comprise an N threshold highest ranking query suggestions, wherein N is a pre-determined threshold; and
provide the top ranked query suggestions to the user in the selectable user interface.

11. The medium as recited in claim 9, further comprising instructions to:
generate one or more type-ahead query candidates from probable spelling correction candidates for the partial query, when a spelling correction candidate exists; and
generate one or more type-ahead query candidate by treating the partial query and the one or more type-ahead query candidates generated during spelling correction as an acronym and identifying probable acronym expansions using a database of known global acronym expansions corresponding to the search domain.

12. The medium as recited in claim 9, wherein key-value vectors for a literal string corresponding to the partial query are pre-generated and stored in database where each key-value vector includes the literal string, the one or more type-ahead query candidates, and a confidence level that each of the one or more type-ahead query candidates is relevant to the partial query.

13. The medium as recited in claim 9, further comprising instructions to:
dynamically update the ranked query suggestions presented to the user, responsive to the user modifying the partial query.

14. The medium as recited in claim 9, wherein the search domain is in a field of job searching within ajob-related professional social network, and wherein the search domain includes contextual information for at least one of industry, company, job title, skill or pre-defined job-related keywords.

15. The medium as recited in claim 9, wherein acronym expansion of the partial query is inferred based on context of the partial query and the search domain.

16. The medium as recited in claim 9, further comprising instructions to:
derive a set of type-ahead query candidates by calculating a weighted OR of a literal matching of the partial query and the one or more type-ahead query candidates.

17. A system for providing type-ahead query suggestions, comprising:
a processor configured to execute an application corresponding to a search domain, the application coupled to a user interface configured to enable a user to enter a search query corresponding to the search domain; and
a contextual type-ahead query suggestion engine communicatively integrated with the user interface of the application and executing on at least the processor or an additional processor, the contextual type-ahead query suggestion engine configured to:
receive the search query entered by the user in the user interface, wherein the search query is specific to the search domain;
identify one or more type-ahead query candidates from the search query, wherein each of the one or more type-ahead query candidates has a corresponding confidence level, and wherein the confidence level is a measure of how relevant the type-ahead query candidate is to the search query, wherein at least one of the one or more type-ahead query candidates is an expansion of the search query using spelling correction or acronym expansion, wherein the corresponding confidence level is accessed from a database of key-value vectors, each key-value vector comprising a literal string associated with the search query, the one or more type-ahead query candidates, and a confidence level that each of the one or more type-ahead query candidates is relevant to the search query, and wherein the confidence levels are calculated offline based on the search domain and historical user searches;
for each of the one or more type-ahead query candidates, identify at least one query suggestion corresponding to the type-ahead query candidate and having a suggestion score based on at least one of click-through-rate or context associated with global features of the search domain;
score the query suggestions, wherein a score of the query suggestion is based on both the suggestion score associated with the query suggestion and the confidence level of the corresponding type-ahead query candidate;
compare the scores of the query suggestion corresponding to type-ahead query candidate and search query;
rank the query suggestions based on the score of each query suggestions; and
provide the ranked query suggestions to the user in the user interface to allow the user to select a desired query suggestion from the ranked query suggestions before a full query has been entered by the user.

18. The system as recited in claim 17, wherein the contextual type-ahead query suggestion engine is further configured to:
dynamically update the ranked query suggestions presented to the user, responsive to the user modifying the search query.

19. The system as recited in claim 17, wherein the search domain is in a field of job searching within ajob-related professional social network, and wherein the search domain includes contextual information for at least one of industry, company, job title, skill or pre-defined job-related keywords.

20. The system as recited in claim 17, wherein the contextual type-ahead query suggestion engine is further configured to:
generate one or more type-ahead query candidates from probable spelling correction candidates for the search query, when a spelling correction candidate exists; and
generate one or more type-ahead query candidates by treating the search query and the one or more type-ahead query candidates generated during spelling correction as an acronym and identify probable acronym expansions using a database of known global acronym expansions corresponding to the search domain.
